(19) United States
(12) Patent Application Publication
(10) Pub. No.: US 2015/0203518 A1
(43) Pub. Date: Jul. 23, 2015

(54) IONIC LIQUID

(71) Applicant: NISSHINBO HOLDINGS, INC., Tokyo (JP)

(72) Inventor: Gen Masuda, Chiba-shi (JP)

(73) Assignee: NISSHINBO HOLDINGS, INC., Tokyo (JP)

(21) Appl. No.: 14/125,411

(22) PCT Filed: Jul. 2, 2012
(86) PCT No.: PCT/JP2012/066857

§ 371 Date: Dec. 11, 2013

(30) Foreign Application Priority Data
Jul. 4, 2011 (JP) 2011-147937

(51) Int. Cl. C07F 9/54; C07F 7/08

(52) U.S. Cl. CPC C07F 9/5407; C07F 7/0818

(57) ABSTRACT

An ionic liquid characterized by comprising a phosphonium salt represented by formula (1), which has such characteristic properties that no halogen atom is contained, thermal stability is excellent and hydrophobicity is exerted.

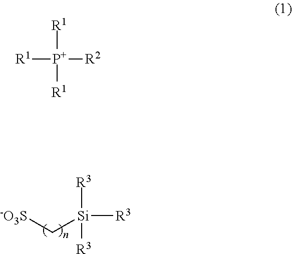

(In the formula, R¹ represents an alkyl group having 1 to 10 carbon atoms; R² represents an alkyl group having 8 to 20 carbon atoms; R³ represents an alkyl group having 1 to 8 carbon atoms; and n represents an integer of 1 to 12; wherein the number of carbon atoms in R² is greater than that in R¹.)

### TECHNICAL FIELD

The present invention relates to an ionic liquid. More specifically, the invention relates to an ionic liquid composed of tetraalkylphosphonium cations and trialkylsilyl group-containing alkylsulfonic acid anions.

### BACKGROUND ART

Most ionic liquids known to date contain halogen atoms such as fluorine atoms on the anions, and thus pose a problem in terms of their environmental impact. In addition, production costs are high. Improvements in these areas have been desired.

In light of the above, ionic liquids of types that do not contain halogen atoms have also been developed (see, for example, Patent Documents 1 and 2). However, compared to ionic liquids which contain fluorine atoms, these have drawbacks such as a high viscosity and a low heat resistance (low decomposition point).

In general, many ionic liquids exhibit hydrophilic properties, although such hydrophilicity itself is often a problem, as in cases where there is a desire to lower the water content and in cases where separation with water is required.

Hence, ionic liquids possessing hydrophobicity to an extent such as to undergo phase separation with water have also been developed (see, for example, Patent Document 3). However, these ionic liquids include fluorine atoms.

Accordingly, ionic liquids which are halogen-free, have an excellent heat resistance, and moreover possess hydrophobic properties have not hitherto been known.

### PRIOR-ART DOCUMENTS

### Patent Documents

Patent Document 1: JP-A 2005-82534

Patent Document 2: JP-A 2005-232019

Patent Document 3: JP-A 2005-314332

Patent Document 4: JP-A 2005-535690

Patent Document 5: JP-A 2009-543105

### SUMMARY OF THE INVENTION

### Problems to be Solvent by the Invention

It is therefore an object of the present invention to provide an ionic liquid which does not contain halogen atoms, has an excellent heat stability, and exhibits hydrophobic properties.

### Means for Solving the Problems

The inventor, as a result of conducting extensive investigations aimed at achieving the above objects, has discovered that a salt which is composed of an asymmetric tetraalkylphosphonium cation having relatively long alkyl chains and a trialkylsilyl group-containing alkylsulfonic acid anion forms an ionic liquid. The inventor has also discovered that this ionic liquid, in spite of being halogen-free, has a good heat stability and also exhibits hydrophobic properties.

It should be noted that salts composed of trialkylsilyl group-containing alkylsulfonic acid anions and onium ions have been disclosed in, for example, Patent Documents 4 and 5, but such salts are not ionic liquids.

Accordingly, the invention provides:
1. An ionic liquid characterized by including a phosphonium salt of formula (1)

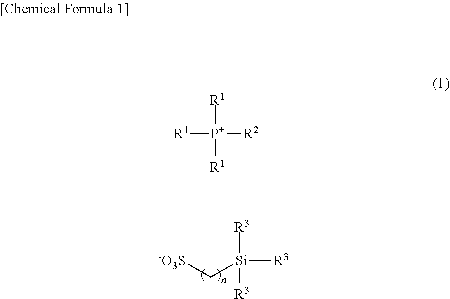

(wherein R¹ is an alkyl group of 1 to 10 carbons, R³ is an alkyl group of 8 to 20 carbons, R³ is an alkyl group of 1 to 8 carbons, and n is an integer from 1 to 12, with the proviso that the number of carbons in R³ is higher than the number of carbons in R¹);
2. The ionic liquid of 1 above, wherein R³ is a straight-chain alkyl group of 10 to 20 carbons;
3. The ionic liquid of 1 or 2 above, wherein R¹ is n-butyl;
4. The ionic liquid of any one of 1 to 3 above, wherein R³ is methyl; and
5. The ionic liquid of any one of 1 to 4 above, wherein n is 3.

### Advantageous Effects of the Invention

The ionic liquid of the invention is halogen-free, has little environment impact and, in spite of being halogen-free, has a good heat resistance.

In addition, the ionic liquid of the invention exhibits hydrophobic properties and thus has the advantage that it can be easily separated from water.

### BRIEF DESCRIPTION OF THE DIAGRAMS

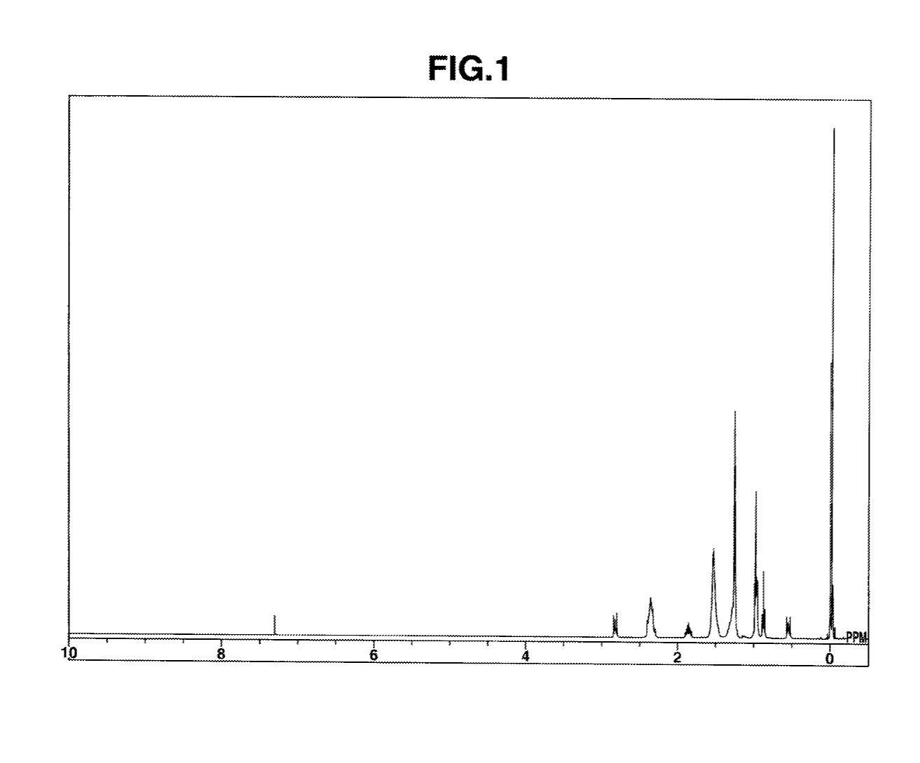

FIG. 1 is an ¹H-NMR spectrum of Compound (1) obtained in Example 1.

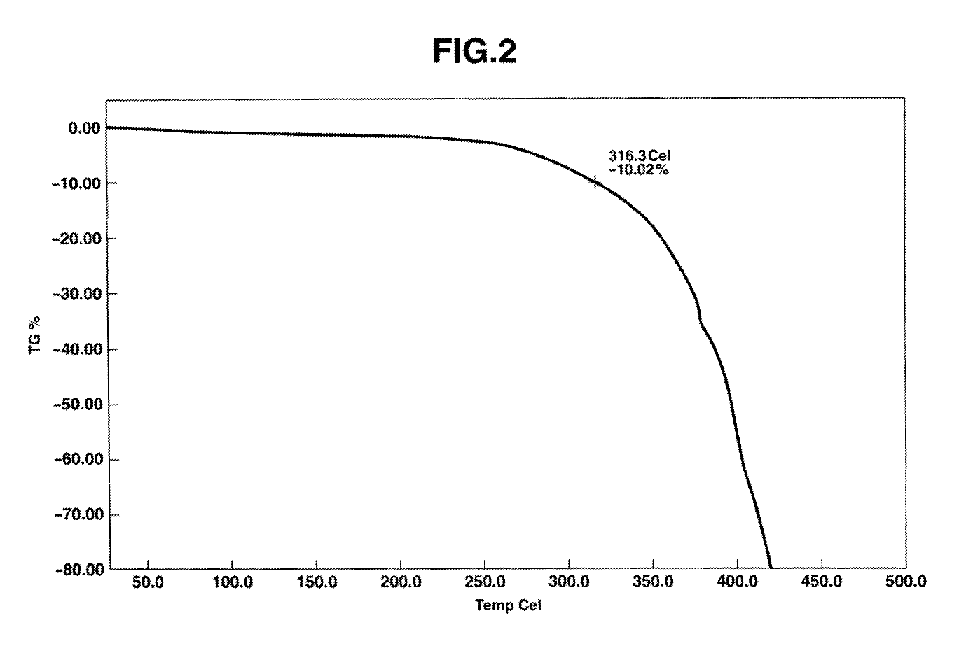

FIG. 2 is a chart showing the decomposition point of Compound (1) obtained in Example 1.

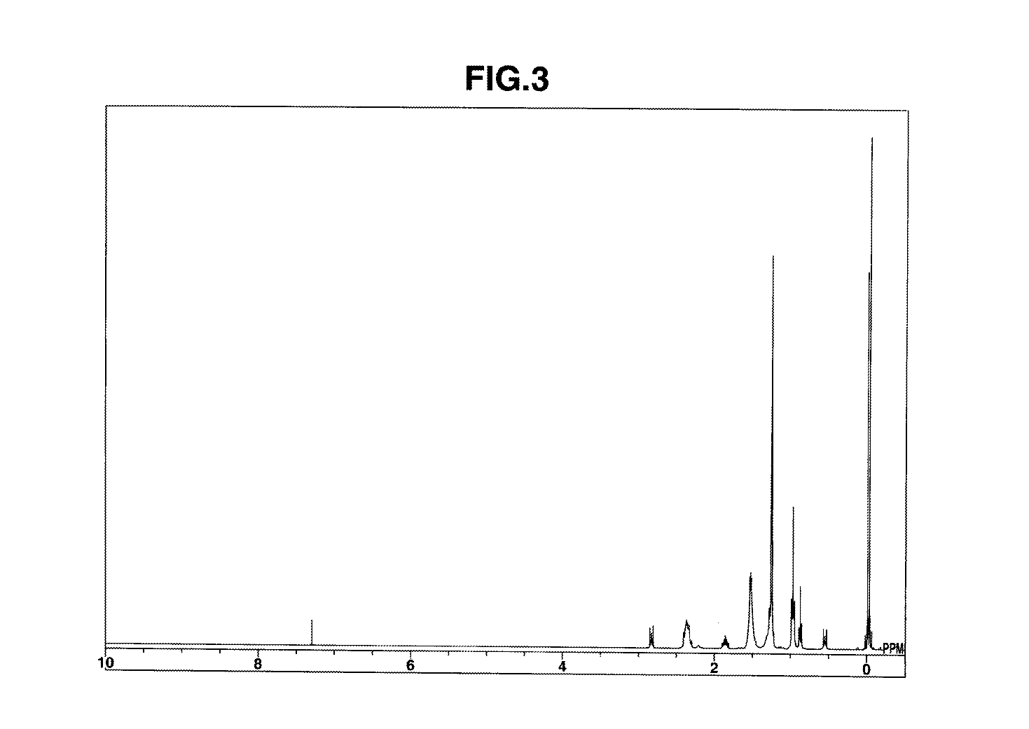

FIG. 3 is an ¹H-NMR spectrum of Compound (2) obtained in Example 2.

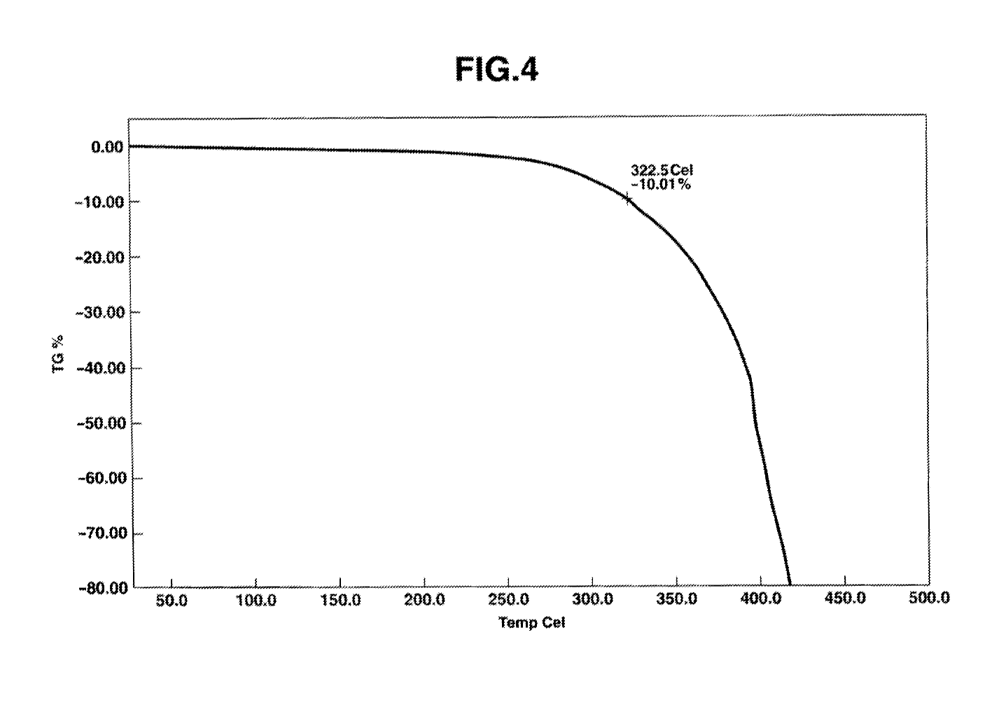

FIG. 4 is a chart showing the decomposition point of Compound (2) obtained in Example 2.

### BEST MODE FOR CARRYING OUT THE INVENTION

The invention is described more fully below.

In above formula (1), the alkyl group of 1 to 10 carbons may be straight-chained, branched or cyclic, and is exemplified by methyl, ethyl, n-propyl, i-propyl, c-propyl, n-butyl, i-butyl, s-butyl, t-butyl, c-butyl, n-pentyl, c-pentyl, n-hexyl, c-hexyl, n-heptyl, n-octyl, n-nonyl and n-decyl.

The alkyl group of 8 to 20 carbons may be straight-chained, branched or cyclic, and is exemplified by n-octyl, 2-ethylhexyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

The alkyl group of 1 to 8 carbons may be straight-chained, branched or cyclic, and is exemplified by the same groups as those having from 1 to 8 carbons mentioned above as examples of alkyl groups of 1 to 10 carbons.

In particular, in this invention, R¹ is preferably a straight-chain alkyl group of 2 to 8 carbons, more preferably a straight-chain alkyl group of 3 to 8 carbons, and even more preferably a straight-chain alkyl group of 4 to 8 carbons. Taking into account such factors as the properties (hydrophobicity, heat resistance) and production costs of the ionic liquid of the invention, n-butyl is most preferred.

Taking into account the properties (hydrophobicity, heat resistance) of the ionic liquid of the invention, R² is preferably a straight-chain alkyl group of 10 to 20 carbons, and more preferably a straight-chain alkyl group of 12 to 20 carbons.

R³ is preferably an alkyl group of 1 to 4 carbons, more preferably an alkyl group of 1 to 3 carbons, and most preferably methyl.

The letter n is preferably from 1 to 8, more preferably from 2 to 6, and even more preferably 2 or 3. From the standpoint of cost, n is most preferably 3.

The ionic liquid of the invention can be produced by reacting a trialkylsilyl group-containing alkylsulfonate with a tetraalkylphosphonium halide of the formula R¹₃R²PX (where X is a halogen atom) within a solvent.

Here, a sodium salt, potassium salt, silver salt or the like may be used as the sulfonate.

Examples of the halogen atom include fluorine, chlorine, bromine and iodine. A chlorine atom or a bromine atom is preferred.

The solvent may be either water or an organic solvent. However because the ionic liquid of the invention that has been formed is hydrophobic and separates with water into two phases, the use of water facilitates operations such as product separation.

In the above reaction, the R¹₃R²PX (where X is a halogen atom) and the trialkylsilyl group-containing alkylsulfonate are used in a ratio, expressed as a molar ratio, which may be set to from about 5:1 to about 1:5. Use in a ratio close to 1:1 is generally preferred.

Following reaction completion, the target product can be obtained by carrying out an ordinary work-up.

Another example of a method of producing the ionic liquid of the invention is a neutralization method which uses an ion-exchange resin.

In such a neutralization method, first the trialkylsilyl group-containing alkylsulfonate and the tetraalkylphosphonium salt of the formula R¹₃R²PX are converted, by using, respectively, a cation-exchange resin and an anion-exchange resin, to a trialkylsilyl group-containing alkylsulfonic acid and a tetraalkylphosphonium hydroxide, following which the two products are mixed together.

When this neutralization method is employed in the invention, there are no particular limitations on the sulfonic acid, the phosphonium salt, and also, insofar as ion exchange occurs, the counterions. However, from the standpoint of cost, the sulfonate is preferably a sodium salt, potassium salt or the like. The counterion for the phosphonium salt is preferably a halogen ion. From the standpoint of cost, a chlorine ion or bromine ion is especially preferred.

The molar ratio of the trialkylsilyl group-containing alkylsulfonic acid and the tetraalkylphosphonium hydroxide in the neutralization reaction is not particularly limited, and may be set to from about 5:1 to about 1:5. From the standpoint of cost, it is preferable for the reaction to be carried out at a ratio close to 1:1, and it is especially preferable to use the point of neutralization of the aqueous phase as the reaction endpoint.

The ionic liquid of the invention can be easily obtained because the organic phase that forms following mixture of the trialkylsilyl group-containing alkylsulfonic acid with the tetraalkylphosphonium hydroxide separates from the aqueous phase.

The ionic liquid of the invention described above has such a degree of hydrophobicity that, when mixed with an equal volume of water, the mixture completely separates into two phases. For this reason, it is useful as a reaction solvent or an extraction solvent. In particular, because it is a halogen-free ionic liquid, it is useful as a green solvent having a low environment impact.

In addition, the ionic liquid of the invention can be used as an electrolyte (electrolytic solution) for power storage devices, or as an antistatic agent or plasticizer for addition to polymer materials such as rubbers and plastics. In particular, because the ionic liquid of the invention has a good thermal stability, it can be advantageously used as an electrolyte (electrolytic solution) in devices which are required to be heat resistant, and as antistatic agents or plasticizers used in components made of polymer materials required to be heat resistant.

### EXAMPLES

Examples of the invention are given below by way of illustration, although the invention is not limited by the following Examples.

The analytical instruments and conditions used in the examples were as follows.

[1] ¹H-NMR Spectrum
Instrument: AL-400, from JEOL Ltd.
Solvent: Deuterated chloroform

[2] Melting Point and Tg
Instrument: DSC 6200, from Seiko Instruments, Inc.
Measurement conditions:
   Measured while raising the temperature 10° C./min from 20° C. to 60° C., lowering the temperature 1° C./min from 60° C. to −90°, holding the temperature at −90° C. for 1 minute, then raising the temperature 1° C./min from −90° C. to 60° C.

[3] Decomposition Point
Instrument: TG-DTA 6200, from Seiko Instruments, Inc.
Measurement conditions:
   Measured in an air atmosphere while raising the temperature 10° C./min from 30° C. to 500° C.

### Example 1

### Synthesis of Compound (1)

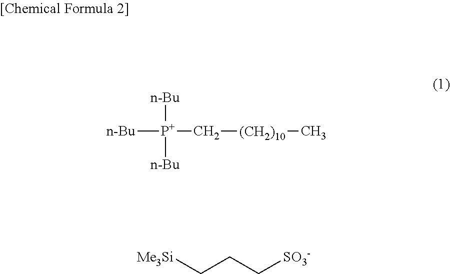

3-(Trimethylsilyl)-1-propanesulfonic acid sodium salt (Sigma-Aldrich), 1.00 g, was dissolved in 120 mL of ion-exchanged water. To this solution was added an already prepared solution of 2.03 g of tributyldodecylphosphonium bromide (Tokyo Chemical Industry Co., Ltd.) dissolved in 80 mL of ion-exchanged water, and the resulting mixture was stirred overnight at room temperature. The reaction mixture at this time was initially cloudy; when left at rest following overnight reaction, the mixture separated into two phases. Ethyl acetate (Wako Pure Chemical Industries Co., Ltd.), 50 mL, was added to this reaction mixture and extraction of the organic phase was carried out. This operation was repeated twice, following which the organic phases were combined and washed twice with 50 mL of ion-exchanged water. About 20 g of potassium carbonate (Wako Pure Chemical Industries, Ltd.) was added to the organic phase to effect drying and the solids were removed by filtration, following which the solvent was distilled off, giving 2.22 g (yield, 870) of the target substance, Compound (1), as a clear, colorless liquid. FIG. 1 shows the ¹H-NMR spectrum of Compound (1).

A melting point was not observed for this compound, but the glass transition point (Tg) was −63° C. As shown in FIG. 2, the decomposition point was 316° C. (100).

In addition, when this Compound (1) was mixed with an equal volume of water, the mixture separated completely into two phases, confirming that Compound (1) is hydrophobic.

### Example 2

### Synthesis of Compound (2)

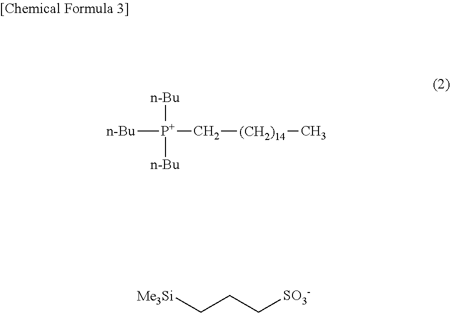

Aside from changing the 2.03 g of tributyldodecylphosphonium bromide to 2.28 g of tributylhexadecylphosphonium bromide (Tokyo Chemical Industry Co., Ltd.), the same operations were carried out as in Example 1, giving 2.12 g (yield, 770) of Compound (2) as a clear, colorless liquid. FIG. 3 shows the ¹H-NMR spectrum of Compound (2).

The melting point of this compound was −41° C. As shown in FIG. 4, the decomposition point was 322° C. (100).

In addition, when this Compound (2) was mixed with an equal volume of water, the mixture separated completely into two phases, confirming that Compound (2) is hydrophobic.

1. An ionic liquid characterized by comprising a phosphonium salt of formula (1) 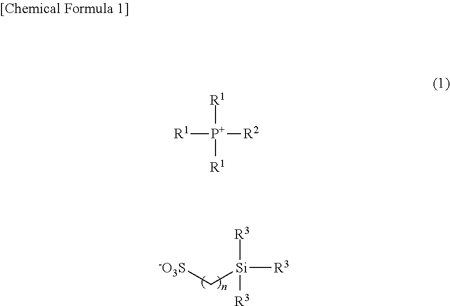
(wherein R¹ is an alkyl group of 1 to 10 carbons, R² is an alkyl group of 8 to 20 carbons, R³ is an alkyl group of 1 to 8 carbons, and n is an integer from 1 to 12, with the proviso that the number of carbons in R² is higher than the number of carbons in R¹).

2. The ionic liquid of claim 1, wherein R² is a straight-chain alkyl group of 10 to 20 carbons.

3. The ionic liquid of claim 1, wherein R¹ is n-butyl.

4. The ionic liquid of claims 1, wherein R³ is methyl.

5. The ionic liquid of claim 1, wherein n is 3.

6. The ionic liquid of claim 2, wherein R¹ is n-butyl.

7. The ionic liquid of claims 2, wherein R³ is methyl.

8. The ionic liquid of claims 3, wherein R³ is methyl.

9. The ionic liquid of claim 2, wherein n is 3.

10. The ionic liquid of claim 3, wherein n is 3.

11. The ionic liquid of claim 4, wherein n is 3.
